(19) United States
(12) Patent Application Publication
(10) Pub. No.: US 2007/0070436 A1
(43) Pub. Date: Mar. 29, 2007

(54) Image forming apparatus and method of controlling the apparatus

(75) Inventor: Kiyoshi Iwaki, Izunokuni-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/232,863

(22) Filed: Sep. 23, 2005

(51) Int. Cl. H04N 1/40

(52) U.S. Cl. 358/448; 358/1.15

(57) ABSTRACT

When a document image is read out by a scanner 36, the read-out image data is temporarily stored in a RAM 22. Each time adjustment-use data is set, the image data in the RAM 22 is adjusted in accordance with the adjustment-use data. The adjusted image data is displayed on a liquid-crystal display image screen 4a of the control panel 4. Where the displayed image is accepted by the user, the adjusted image is printed by a printer 37 or stored in a hard disk drive 25.

### BACKGROUND OF THE INVENTION

1. Field of the Invention

The present invention relates to an image forming apparatus having the function of adjusting an image which is read out from a document.

2. Description of the Related Art

An image forming apparatus, such as a copying machine, optically reads out an image from a document sheet on a document sheet rest, forms an electrostatic latent image corresponding to the read-out image on a surface of a photosensitive drum, develops the electrostatic latent image by a developing agent into a visible image, and prints it on a paper sheet.

The read-out image from the document sheet is adjusted in accordance with adjustment-use data initially set by the user. As the contents of the adjustment, there are, for example, an adjustment corresponding to the kinds of documents (characters, photos, etc.), an adjustment of the image quality (concentration, contrast, etc.), an adjustment of an image layout (2 in 1, rotation, etc.), and so on.

The adjusted image is displayed on a display image screen of a control panel of the image forming apparatus or on a display of a personal computer which is network-connected to the image forming apparatus.

Where the displayed image is accepted by the user, the adjusted image as set out above is printed.

Where the displayed image is not accepted, a document image is again read out and adjustment-use data is re-set. The again read-out image is re-adjusted in accordance with the re-set adjustment-use data.

The re-adjusted image is displayed on a display image screen of the control panel or on a display of the personal computer. If the displayed image can be acceptable by the user, then the re-adjusted image can be printed.

It is thus time-consuming and cumbersome for the user to have to repeat the reading-out of the image.

### BRIEF SUMMARY OF THE INVENTION

It is accordingly the object of the present invention to provide an image forming apparatus which can repeatedly adjust a once read-out image any number of times and readily obtain a desired image without repeating the reading-out of the image.

In one aspect of the present invention there is provided an image forming apparatus comprising a scanner configured to read out a document image; a memory section configured to temporarily store the image read out by the scanner; an operation section configured to set adjustment-use data to the image read out by the scanner; an adjusting section configured to, each time adjustment-use data is set by the operating section, adjust the image in the memory section in accordance with the adjustment-use data; a display section configured to display the image adjusted by the adjusting section; an image output section; and a control section configured to, where an image on the display section is accepted, allow the image which is adjusted by the adjusting section to be output to the output section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a view showing an outer appearance of one embodiment of the present invention;

FIG. 2 is a view showing a control panel of the present embodiment;

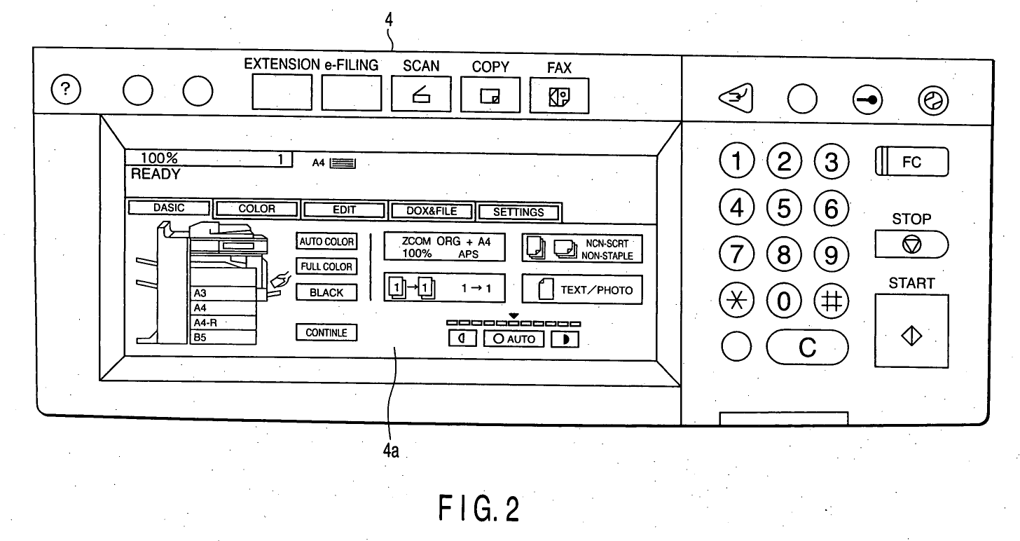

FIG. 3 is a block diagram showing a control circuit of the present embodiment; and

FIG. 4 is a flowchart for explaining the operation of the present embodiment.

### DETAILED DESCRIPTION OF THE INVENTION

With reference to the drawing, an explanation will be made below about one embodiment of the present invention.

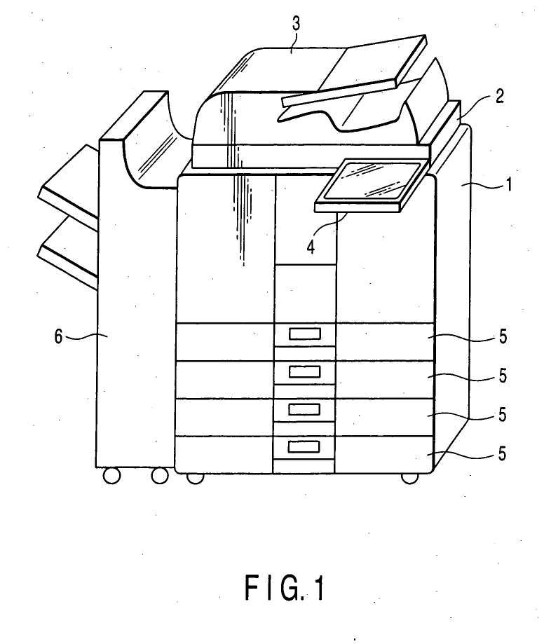

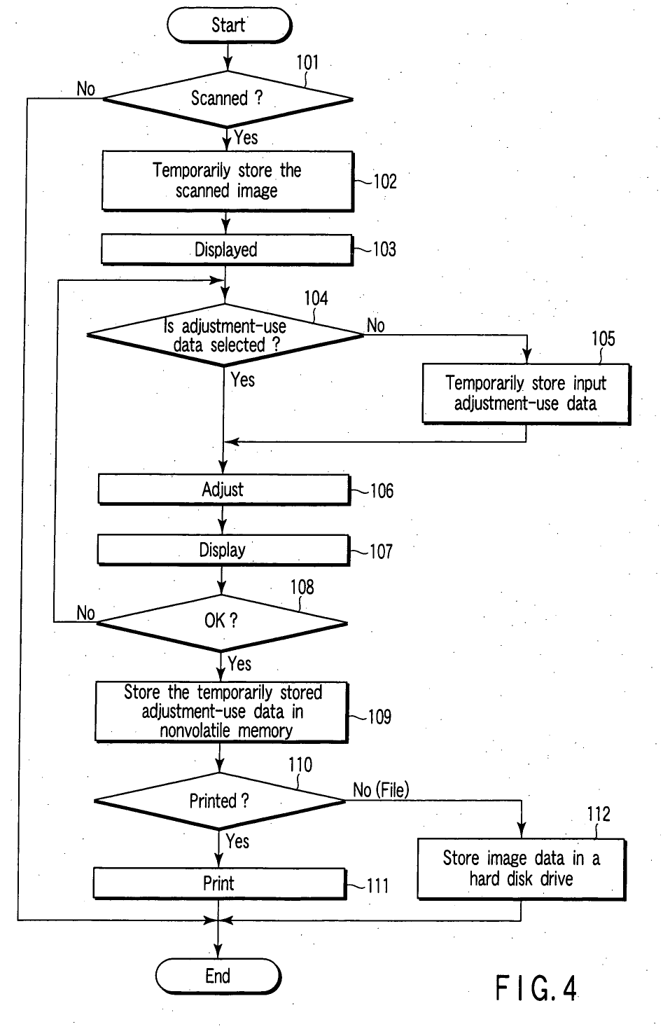

As shown in FIG. 1, a document sheet rest 2 is provided at an upper section of a body 1 of an image forming apparatus and an auto-document feeder (ADF) 3 is so provided over the document sheet rest 2 as to be opened and closed. At the same height as that of the document sheet rest 2, a control panel 4 as shown in FIG. 4 is provided as an operation section. A control panel 4 has various kinds of keys, such as a start key, stop key, filing key, scan key, copy key, facsimile key, and ten keys, as well as a liquid-crystal display image screen as a display section. It is to be noted that, by the operation of the control panel 4, it is possible to set adjustment-use data of a read-out image to a later-described scanner 36 and any of respective adjustment-use data in a later-described nonvolatile memory 24.

A plurality of cassettes 5 are provided at the lower section of the apparatus body 1 to receive various sizes and kinds of paper sheets as an image forming medium 1. A paper discharge unit 6 is provided at a side of the apparatus body 1 to receive a printed paper sheet.

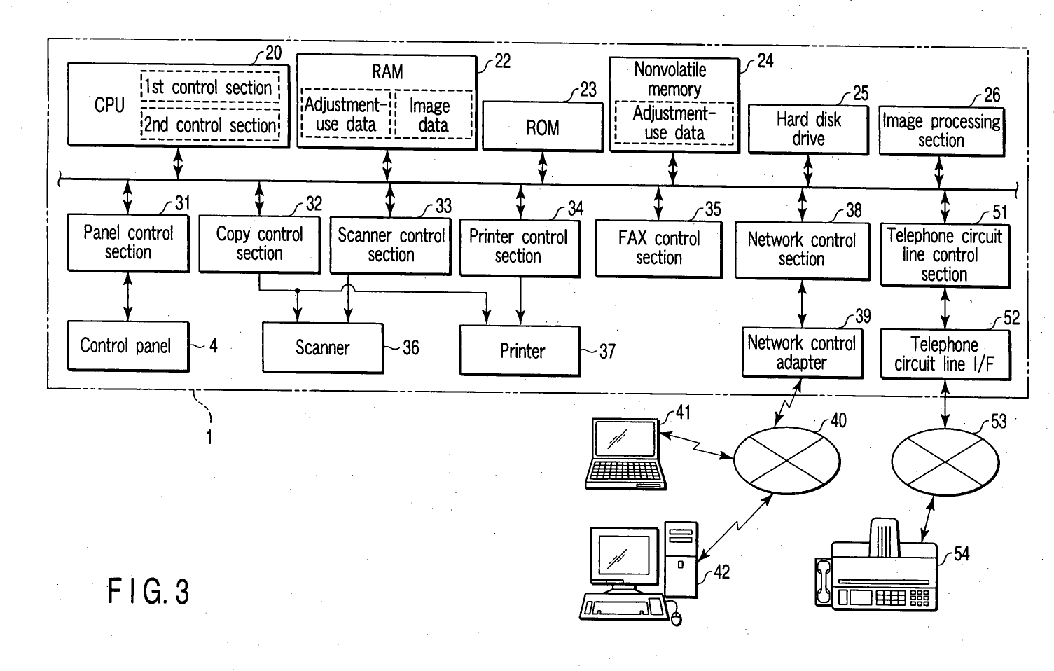

As shown in FIG. 3, a CPU 20 is provided in the apparatus body 1.

To the CPU 20 are connected a RAM (first memory section) 22 for use in a temporary storage of image data and adjustment-use data, a ROM 23 for storing various kinds of control programs, a data memory section, such as a nonvolatile memory (third memory section) 24, for storing the adjustment-use data, a large-capacity hard disk drive (second memory section) 25 for storing the image data, an image processing section 26, a panel control section 31, a copy control section 32, a scanner control section 33, a printer control section 34, a facsimile control section 35, a network control section 38 and a telephone circuit line control section 51.

The image processing section 26 adjusts image data in the RAM 22 in accordance with the adjustment-use data each time the adjustment-use data is set or selected on the control panel 4.

The panel processing section 31 controls the above-mentioned control panel 4. To the copy control section 32 is connected a scanner 36 for optically reading out an image of a document sheet on the document sheet rest 2 as well as a printer (output section) 37 for printing an image processed by the image processing section 26.

The scanner control section 33 controls a scan function (SCAN to BOX function, SCAN to FILE function, SCAN to E-MAIL function) using the scanner 36. The printer control section 34 controls a network print function using the printer 37. The facsimile control section 35 effects fax-transmit/receive control under the network control section 38 and telephone circuit line control section 51.

To the network control section 38 is connected a network adapter (output section) 39 for allowing an image to be network-transmitted and-received. External devices, such as personal computers 41, 42 are connected to the network adapter 39 via a communication network 40. The personal computers 41, 42 each have a display as a display section.

A telephone circuit line interface 52 for allowing the image to be fax-transmitted/received is connected to the telephone circuit line section 51. An external facsimile equipment 54 is connected to the telephone line interface 52 via a public telephone circuit line 53.

On the other hand, the CPU 20 has the following (1) and (2) control sections.

(1) A control section for, when an image which is displayed on a liquid crystal display image screen 4a of the control panel 4 or on a display of the personal computers 41, 42 is accepted by the user, allowing an image adjusted by the image processing section 26 to be output to any of the printer 37, network adapter 39 and telephone circuit line interface 52 or stored in the hard disk drive 25.

(2) A control section for, when an image displayed on the liquid crystal display image screen 4a of the control panel 4 or on a display of the personal computers 41, 42 is accepted by the user, allowing adjustment-use data which is set by the control panel 4 to be stored in the nonvolatile memory 24.

The operation will be explained below by referring to a flowchart of FIG. 4.

When an image of a document sheet on the document sheet rest 2 is read out by the scanner 36 (YES at step 101), the read-out image data (scanned image data) is temporarily stored in the RAM 22 (step 102). And the temporarily stored image data is displayed on the liquid crystal display image screen 4a of the control panel 4 (or on the display of the network-connected personal computers 41, 42) (step 103).

By the operation of the control panel 4, the user selects, as an adjustment-use data for the read-out image data, one of respective kinds of adjustment-use data stored in the nonvolatile memory 24 (YES at step 104). Or the user sets any arbitrary adjustment-use data by the operation of the control panel 4 (NO at step 104). The set adjustment-use data is temporarily stored in the RAM 22 (step 105).

When the adjustment-use data is selected or set, its adjustment-use data and image data in the RAM 22 are sent to the image processing section 26. The image data sent to the image processing section 26 is adjusted (image processed) (step 106). As the contents of the adjustment there are, for example, an adjustment corresponding to the kinds of documents (characters, photos, etc.), an adjustment of an image quality (concentration, contrast, etc.), an adjustment of an image layout (2 in 1, rotation, etc.), and so on.

The adjusted image data is displayed on a liquid crystal display image screen 4a (or on a display of the network-connected personal computers 41, 42) (step 107).

The user decides whether or not the displayed image data is acceptable and, if it is not acceptable, new adjustment-use data is newly selected or set (NO at step 108).

If the new adjustment-use data is newly selected or set, new adjustment-use data and image data in the RAM 22 are sent to an image processing section 26. The image data sent to the image processing section 26 is adjusted in accordance with the new adjustment-use data (step 106).

The adjusted image data is displayed on the liquid crystal display image screen 4a of the control panel 4 (or on the display of the network-connected personal computers 41, 42) (step 107).

The user decides whether or not the displayed image data is acceptable and, if it is not acceptable, the new adjustment-use data is newly selected or set (NO at step 108).

When new adjustment-use data is newly selected or set, new adjustment-use data and image data in the RAM 22 are sent to the image processing section 26. The thus sent image data is adjusted in accordance with the new adjustment-use data (step 106).

The adjusted image data is displayed on the liquid crystal display image screen 4a of the control panel 4 (or on the display of the network-connected personal computers 41, 42) (step 107).

The user decides whether or not the displayed image data is acceptable and, if it is acceptable, its effect is input by the operation of the control panel 4 (YES at a step 108).

When this acceptance is done, adjustment-use data temporarily stored in the RAM 22 is stored in the nonvolatile memory 24 (step 109). The stored adjustment-use data can be used for adjustment from the next time. In accordance with the operation of the start key on the control panel 4, the finally adjusted image data is printed on the paper sheet-step 111. Where the filing key on the control panel 4 is operated, the finally adjusted image data is stored in the hard disk drive 25 (step 112).

Since, as set out above, the image data read out by the scanner 36 is temporarily stored in the RAM 22, once read-out image data can be repeatedly adjusted any number of times. Without repeating the image read-out by the scanner 36 it is possible to readily obtain any image data as the user is desired.

In the respective embodiment, although only printing is explained as an example of outputting the adjusted image data, it is also possible to network-transmit the adjusted image data to external personal computers 41, 42. It is possible to fax-transmit the adjusted image data to the facsimile equipment 54.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising:
a scanner configured to read out a document image;
a memory section configured to temporarily store the image read out by the scanner;
an operation section configured to set adjustment-use data to the image read out by the scanner;
an image processing section configured to, each time the adjustment-use data is set by the operation section, allow the image in the memory section to be adjusted in accordance with the adjustment-use data;
a display section configured to display the image adjusted by the image processing section;
an output section for image outputting;
a control section configured to, when the image which is displayed on the display section is accepted, output the adjusted image from the image processing section to the output section.

2. An apparatus according to claim 1, wherein the operation section is comprised of a control panel.

3. An apparatus according to claim 1, wherein the display section is comprised of any of a display image screen of the operation section or a display of a network-connected personal computer.

4. An apparatus according to claim 1, wherein the output section is comprised of a printer.

5. An apparatus according to claim 1, wherein the output section is comprised of at least one of a printer for printing the image, a network adapter for allowing the image to be network-transmitted, and a telephone circuit line interface for allowing the image to be fax-transmitted.

6. An apparatus according to claim 1, further comprising a data memory section configured to store the adjustment-use data.

7. An apparatus according to claim 6, wherein the operation section is comprised of a section for setting the adjustment-use data and a section for selecting any of respective adjustment-use data in the data memory section.

8. An apparatus according to claim 7, wherein the image processing section is configured to, each time the adjustment-use data is set or selected by the operation section, adjust the image in the memory section in accordance with the adjustment-use data.

9. An apparatus according to claim 7, further comprising a control section configured to, when the image on the display section is accepted, allow the adjustment-use data which is set by the operation section to be stored in the data memory section.

10. An image forming apparatus comprising:
a scanner configured to read out a document image;
a first memory section configured to temporarily store the image read out by the scanner;
an operation section configured to set adjustment-use data to the image read out by the scanner;
an image processing section configured to, each time the adjustment-use data is set by the operation section, adjust the image in the first memory section in accordance with the adjustment-use data;
a display section configured to display the image adjusted by the image processing section;
an image output section;
a second memory section for image memory; and
a control section configured to, when the image on the display section is accepted, allow the image which is adjusted by the image processing section to be output from the output section or to be stored in the second memory section.

11. An apparatus according to claim 10, wherein the control section is comprised of a control panel.

12. An apparatus according to claim 10, wherein the display section is comprised of any of a display image screen of the control panel and a display of network-connected personal computer.

13. An apparatus according to claim 10, wherein the output section is comprised of a printer for printing the image.

14. An apparatus according to claim 10, wherein the output section is comprised of at least one of the printer for printing the image, a network adaptor for allowing the image to be network-transmitted, and a telephone circuit line interface for allowing the image to be fax-transmitted.

15. An apparatus according to claim 10, wherein the second memory section is comprised of a hard disk drive.

16. An apparatus according to claim 10, further comprising a third memory section for storing the adjustment-use data.

17. An apparatus according to claim 16, wherein the operation section is comprised of a section for setting the adjustment-use data or a section for selecting any of respective adjustment-use data in the third memory section.

18. An apparatus according to claim 17, wherein a control section is configured to, when the image on the display section is accepted, allow the adjustment-use data which is set by the operation section to be stored in the third memory section.

19. An apparatus according to claim 17, wherein the image processing section is configured to, each time the adjustment-use data is set or selected by the operation section, adjust the image in the first memory section in accordance with the adjustment-use data.

20. A control method for an image forming apparatus, comprising:
a step of reading out a document image;
a step of temporarily storing the read-out image;
a step of, each time adjustment-use data is set to the read-out image, adjusting the temporarily stored image in accordance with adjustment-use data;
a step of displaying the adjusted image; and
a step of, when the displayed image is accepted, outputting the adjusted image.
